(19) United States
(12) Patent Application Publication
(10) Pub. No.: US 2017/0337481 A1
(43) Pub. Date: Nov. 23, 2017

(54) COMPLEX EMBEDDINGS FOR SIMPLE LINK PREDICTION

(71) Applicant: Xerox Corporation, Norwalk, CT (US)

(72) Inventors: Théo Philippe Trouillon, Echirolles (FR); Guillaume M. Bouchard, London (GB)

(73) Assignee: Xerox Corporation, Norwalk, CT (US)

(21) Appl. No.: 15/156,849

(22) Filed: May 17, 2016

(51) Int. Cl. G06N 7/00; G06F 11/00; G06F 17/30

(52) U.S. Cl. CPC G06N 7/005; G06F 17/3053; G06F 11/004; G06F 2201/805

(57) ABSTRACT

A method for link prediction includes providing training samples for at least one relation. The training samples include positive training samples in which a first of a set of entities is a subject in the relation and a second of the set of entities is an object in the relation. An input matrix is generated for each of the at least one relation, based on the training samples. Parameters of a scoring function which minimize an error between a reconstructed matrix and the input matrix are learned, the parameters including a set of latent factors for each entity, each of the latent factors being a complex number. The parameters of the scoring function may be output for performing link prediction and/or used for predicting an entity for a relation from a part of the reconstructed matrix.

### BACKGROUND

The exemplary embodiment relates to use of structured databases and finds particular application in connection with a system and method of link prediction for extracting new relations from existing ones.

Web-scale knowledge bases (KBs) provide a structured representation of immense collections of knowledge. These KBs enable a wide range of applications, such as recommender systems, question answering, and automated personal agents, to retrieve information through structured queries. Examples of such KBs include DBPedia, Freebase, and the Google Knowledge Vault (Auer, et al., “Dbpedia: A nucleus for a web of open data,” 6th Int+l Semantic Web Conference, pp. 11-15, 2007; Bollacker, et al., “Freebase: a collaboratively created graph database for structuring human knowledge,” Proc. ACM SIGMOD Int'l Conf. on Management of data, pp. 1247-1250, 2008; Dong, et al., “Knowledge vault: A web-scale approach to probabilistic knowledge fusion,” Proc. 20th ACM SIGKDD Int'l Conf. on Knowledge Discovery and Data Mining, pp. 601-610, 2014). Despite their size, these KBs are incomplete. The task of predicting missing entries, known as link prediction, has been a focus in Statistical Relational Learning (SRL) (Getoor, et al., “Introduction to Statistical Relational Learning (Adaptive Computation and Machine Learning),” The MIT Press, 2007).

KBs express data as a directed graph with labeled edges (relations) between nodes (entities). Natural redundancies among the recorded relations often make it possible to supply the missing entries of a KB. As an example, the relation CountryOfBirth is not recorded for all entities, but it can easily be inferred if the relation CityOfBirth is known. A goal of link prediction is the automatic discovery of such regularities. However, many relations are non-deterministic. For example, the combination of the two facts IsBornIn(John,Athens) and IsLocatedIn(Athens,Greece) does not always imply the fact HasNationality(John,Greece). Hence, facts involving these relations or entities may be handled in a probabilistic fashion.

One method for handling non-deterministic relations is to state the link prediction task as a 3D binary tensor completion problem, where each slice is the binary adjacency matrix of one relation type in the knowledge graph. Completion of the tensor based on low rank factorization (embeddings) has been investigated (Koren, et al., “Matrix factorization techniques for recommender systems,” Computer, 42(8):30-37, 2009). In this approach, a partially observed matrix or tensor is decomposed into a product of embedding matrices with much smaller rank, resulting in fixed-dimensional vector representations for each entity and relation in the database. For a given fact r(s,o) in which subject s is linked to object o through relation r, the score can then be recovered as a multi-linear product between the embedding vectors of s, r, and o (Nickel, et al., “A Review of Relational Machine Learning for Knowledge Graphs,” pp. 1-23, 2015, hereinafter, Nickel 2015a).

Binary relations in KBs exhibit various types of patterns: hierarchies and compositions like FatherOf, OlderThan or IsPartOf—with partial/total, strict/non-strict orders—and equivalence relations like IsSimilarTo. To be useful, a relational model should be able to learn all combinations of these properties, namely reflexivity/ireflexivity, symmetry/antisymmetry and transitivity, and also be linear in both time and memory in order to scale to the size of current KBs (Bordes, et al, “Irreflexive and Hierarchical Relations as Translations,” CoRR 2013, hereinafter, Bordes 2013b).

Dot products of embeddings scale well and can naturally handle both symmetry and (ireflexivity) of relations. Transitivity can be obtained by using an appropriate loss function, (Bouchard, et al., “On Approximate Reasoning Capabilities of Low-Rank Vector Spaces,” AAAI Spring Symp. on Knowledge Representation and Reasoning (KRR): Integrating Symbolic and Neural Approaches, 2015). However, dealing with antisymmetric relations generally implies an explosion of the number of parameters, making models prone to overfitting (Nickel, “A Three-Way Model for Collective Learning on Multi-Relational Data,” 28th Int'l Conf. on Machine Learning, pp. 80-816, 2011, hereinafter, Nickel 2011; Socher, et al., “Reasoning With Neural Tensor Networks for Knowledge Base Completion, Nips, pp. 926-934, 2013, hereinafter Socher 2013). Finding a good balance between expressiveness and parameter space size is therefore advantageous in developing embedding models.

Early spectral theories in linear algebra focused on the use of bi-linear forms for matrix factorization. Similarly, early approaches for tensor factorization were based on decompositions in the real domain, such as the Canonical Polyadic (CP) decomposition. In link prediction, antisymmetry of relations lead to the study of asymmetric extensions of tensors, either considering independent embeddings or by considering relations as matrices instead of vectors in the RESCAL model (Nickel, et al., “A Three-Way Model for Collective Learning on Multi-Relational Data,” 28th Intl Conf. on Machine Learning, pp. 809-816, 2011, hereinafter, Nickel 2011; Riedel, et al., “Relation extraction with matrix factorization and universal schemas,” NAACL, 2013, hereinafter, Reidel 2013). Direct extensions are based on uni-, bi- and trigram latent factors for triplets data, as well as a low-rank relation matrix (Jenatton, et al., “A Latent Factor Model for Highly Multi-relational Data,” Adv. in Neural Information Processing Systems, 25, pp. 3167-3175, 2012).

Pairwise interactions are also considered to improve prediction performances. For example, the Universal Schema approach (Reidel 2013) factorizes a 2D unfolding of the tensor that is a matrix of entity pairs vs. relations.

Neural Tensor Network (NTN) models, combine linear transformations and multiple bilinear forms of subject and object embeddings to jointly feed them into a nonlinear neural layer (Socher 2013). The non-linearity and multiple ways of including interactions between embeddings gives this approach an advantage in expressiveness over models with simpler scoring functions, such as DistMult (Yang, et al., “Embedding entities and relations for learning and inference in knowledge bases,” ICLR, pp. 1-13, 2015, hereinafter, Yang 2015) and RESCAL. A disadvantage lies in the large number of parameters, making the NTN model harder to train and causing overfitting.

The basic multi-linear model (symmetric in object and subject for every relation), such as the DistMult model of Yang 2015, still leads to good performance, due in part to its simplicity. The TransE model also embeds entities and relations in the same space and imposes a geometrical structural bias into the model: the subject entity vector should be close to the object entity vector once translated by the relation vector (Bordes, Antoine, et al., “Translating Embeddings for Modeling Multi-relational Data,” NIPS, pp. 1-9, 2013, hereinafter, Bordes 2013a)

A more recent method for handling antisymmetry is via the Holographic Embeddings (HolE) model (Nickel, et al., “Holographic Embeddings of Knowledge Graphs,” 2015, hereinafter, Nickel 2015b). In HolE, a circular correlation is used for combining entity embeddings, measuring the covariance between embeddings at different dimension shifts. However, the asymmetry in the composition function in HolE stems from the asymmetry of circular correlation, which is computationally expensive (anO)nlog(n) operation).

There remains a need for a system and method for link prediction which is efficient while being able to handle antisymmetric relations.

### INCORPORATION BY REFERENCE

The following references, the disclosures of which are incorporated herein by reference, are mentioned:

Recommender systems are described, for example, in U.S. Pat. No. 7,756,753, U.S. Pub. Nos. 20130218914, 20130226839, 20140180760, and 20140258027, U.S. application Ser. No. 14/669,153, filed Mar. 26, 2015, entitled TIME-SENSITIVE COLLABORATIVE FILTERING THROUGH ADAPTIVE MATRIX COMPLETION, by Jean-Michel Renders, and U.S. application Ser. No. 15/079,669, filed Mar. 24, 2016, entitled ADAPTIVE COLLABORATIVE FILTERING WITH EXTENDED KALMAN FILTERS AND MULTI-ARMED BANDITS, by Jean Michel Renders.

### BRIEF DESCRIPTION

In accordance with one aspect of the exemplary embodiment, a method for link prediction includes providing training samples for at least one relation, the training samples comprising positive training samples in which a first of a set of entities is a subject in the relation and a second of the set of entities is an object in the relation. An input matrix is generated for each of the at least one relation, based on the training samples. Parameters of a scoring function are learnt which minimize an error between a reconstructed matrix and the input matrix. The parameters include a set of latent factors for each entity. Each of the latent factors is a complex number. The parameters of the scoring function may be output for performing link prediction or an entity for a relation may be predicted based on the parameters.

The reconstructed matrix may be output for performing link prediction and/or an entity for a relation may be predicted from the reconstructed matrix.

One or more steps of the method may be performed with a processor.

In accordance with another aspect of the exemplary embodiment, a link prediction system includes memory which stores values for training samples for at least one relation. The training samples include positive training samples in which a first of a set of entities is a subject in the relation and a second of the set of entities is an object in the relation. A generation component generates an input matrix for each of the at least one relation, based on the training samples. A completion component learns parameters of a scoring function which minimize an error between a reconstructed matrix and the input matrix. The parameters include a set of latent factors for each entity. Each of the latent factors is a complex number. A processor implements the generation component and the completion component.

In accordance with one aspect of the exemplary embodiment, a method for link prediction includes providing an input matrix for each of at least one relation. Each input matrix includes a value for each of a subset of a set entity pairs represented in the input matrix. Each entity pair includes a first of the set of entities, which is a subject in the respective relation, and a second of the set of entities, which is an object in the respective relation. For each of the at least one relation, parameters of a scoring function are learned which minimize an error between a reconstructed matrix and the input matrix, the parameters including a set of latent factors for each entity, each of the latent factors being a complex number, and parameters of the relation, elements of the reconstructed matrix each corresponding to the dot product of the latent factors for a first entity, the complex conjugates of the latent factors for a second entity, and the parameters of the relation. The method further includes outputting the parameters of the scoring function or predicting an entity for a relation based on the parameters.

One or more of the steps of the method may be performed with a processor.

### BRIEF DESCRIPTION OF THE DRAWINGS

FIG. 1 is a functional block diagram of a link prediction system in accordance with one aspect of the exemplary embodiment;

FIG. 2 is a flow chart illustrating a method for link prediction in accordance with another aspect of the exemplary embodiment;

FIG. 3 illustrates aspects of the method of FIG. 2;

FIG. 4 illustrates parameters of the scoring function in a single relation case;

FIG. 5 illustrates parameters of the scoring function in a multiple relation case;

FIGS. 6-11 show training, validation and test sets for synthetic data with one symmetric and one antisymmetric relation, where FIGS. 6-8 are plots of the symmetric slice (relation) for the 10 first entities and FIGS. 9-11 are plots of the antisymmetric slice for the 10 first entities;

FIG. 12 shows Average Precision (AP) for each factorization rank ranging from 1 to 50 for different models on a combined symmetry and antisymmetry experiment for the symmetric relation only;

FIG. 13 shows Average Precision (AP) for each factorization rank ranging from 1 to 50 for different models on the combined symmetry and antisymmetry experiment for the antisymmetric relation only;

FIG. 14 shows Overall Average Precision vs. factorization rank; and

FIG. 15 graphically illustrates the influence of the number of negative triples generated per positive training example, on Mean Reciprocal Rank (MRR) and on training time to convergence.

### DETAILED DESCRIPTION

Aspects of the exemplary embodiment are directed to a system and method for link prediction: given a set of binary relations for which at least some of the scores (e.g., true or false) are known, the aim of the link prediction is to predict scores for relations with missing values. The prediction is addressed in the present method through latent factorization using complex-valued embeddings. The composition of these complex-valued embeddings is able to handle a variety of types of binary relations, including symmetric and antisymmetric relations. Compared to existing models, such as the Neural Tensor Model and Holistic Embeddings, the present method based on complex-valued embeddings can be computed more efficiently, as it makes use of the Hermitian dot product, which is the complex counterpart of the standard dot product between real vectors. The method is scalable to large datasets as it remains linear in both space and time, while consistently outperforming alternative approaches on standard link prediction benchmarks.

A binary relation between two entities is represented as a binary value Yₛₒ ε {−1, 1}, where s ε ε is the subject of a relation r ε [symbol] , o ε ε is its object, ε represents a set of entities, and a [symbol] represents a set of relations.

Symmetric relations are those in which two entities give the same value when interchanged, i.e., Yₛₒ=Yₒₛ. As an example if A is a cousin of B is true, then B is a cousin of A is also true.

Antisymmetric relations are those in which two entities always give the opposite value when interchanged, i.e., Yₛₒ=−Yₒₛ. As an example if A is a father of B is true, then A is father of B is never true.

Reflexive relations are those which are always true between an entity and itself, as in the case of the relation is similar to, since entity A is always similar to entity A.

Ireflexive relations are those which are never true between an entity and itself, as in the case of the relation is dissimilar to.

The present system and method are able to perform link prediction for these classes of relations and are particularly useful in the case of antisymmetric relations.

A complex number includes a real part and an imaginary part, and can be formulated as x=a+bi, where a and b are real numbers and i is the imaginary unit, where i=\sqrt{−1}. In this expression, a is the real part and b is the imaginary part of the complex number.

A complex-valued vector is a sequence of entries, each entry corresponding to a complex number, e.g., of the form u={(a₁, b₁), . . . , (aₖ, bₖ)}, where k is the rank of the vector. The present complex-valued vectors are vectors of latent factors in which each (or at least some) of the entries (latent factors) have both a non-zero real part a and a non-zero imaginary part b.

The method is suited to a variety of applications, such as recommender systems and information extraction systems, but is not limited to such applications.

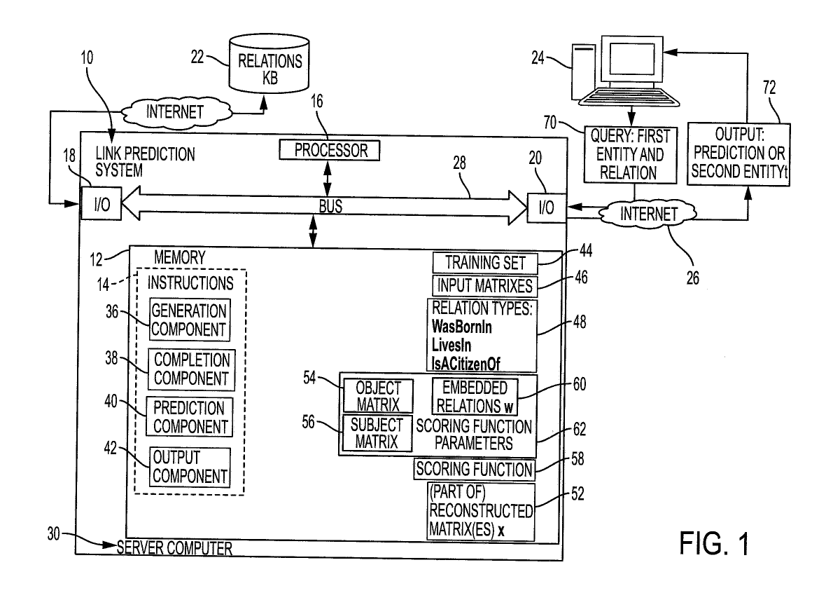

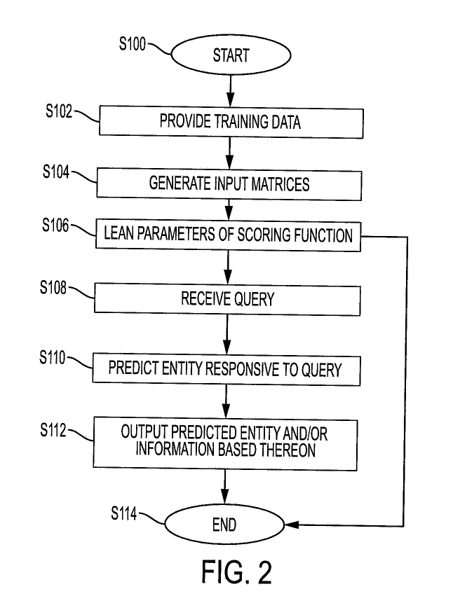

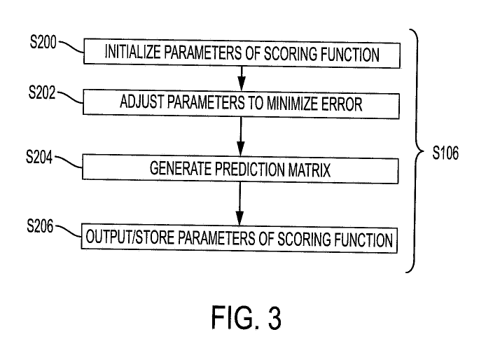

With reference to FIG. 1, a functional block diagram of a computer-implemented link prediction system 10 is shown. The illustrated system 10 includes memory 12 which stores software instructions 14 for performing the method illustrated in FIGS. 2 and 3 and a processor 16 in communication with the memory for executing the instructions. The system 10 also includes one or more input/output (I/O) devices, such as a network interface 18 and a user input output interface 20. The I/O interface 18 may communicate with a knowledge base (KB) 22 which stores relations. The knowledge base may be stored remotely, as shown, e.g., on one or more remote servers, or locally, e.g., in memory 12. The I/O interface 20 may communicate with one or more remote computing devices, such as client device 24, e.g., via a wired or wireless link 26, such as the Internet, or may be directly connected to a display, for displaying information to users, speakers, and a user input device, such as a keyboard or touch or writable screen, and/or a cursor control device, such as mouse, trackball, or the like, for inputting text and for communicating user input information and command selections to the processor device 16. The various hardware components 12, 16, 18, 20 of the system 10 may all be connected by a data/control bus 28.

The computer system 10 may include one or more computing devices 30, such as a PC, such as a desktop, a laptop, palmtop computer, portable digital assistant (PDA), server computer, cellular telephone, tablet computer, pager, combination thereof, or other computing device capable of executing instructions for performing the exemplary method.

The memory 12 may represent any type of non-transitory computer readable medium such as random access memory (RAM), read only memory (ROM), magnetic disk or tape, optical disk, flash memory, or holographic memory. In one embodiment, the memory 12 comprises a combination of random access memory and read only memory. In some embodiments, the processor 16 and memory 12 may be combined in a single chip. Memory 12 stores instructions for performing the exemplary method as well as the processed data.

The network interface 18, 20 allows the computer to communicate with other devices via a computer network, such as a local area network (LAN) or wide area network (WAN), or the internet, and may comprise a modulator/demodulator (MODEM) a router, a cable, and/or Ethernet port.

The digital processor device 16 can be variously embodied, such as by a single-core processor, a dual-core processor (or more generally by a multiple-core processor), a digital processor and cooperating math coprocessor, a digital controller, or the like. The digital processor 16, in addition to executing instructions 14 may also control the operation of the computer 30.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

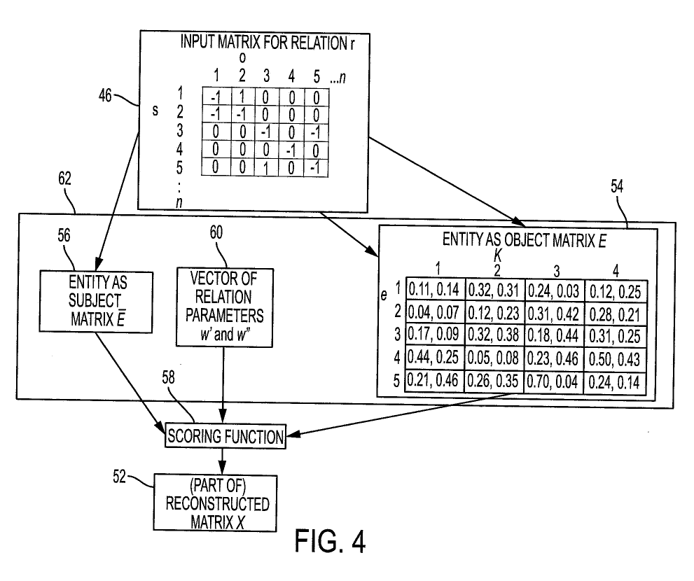

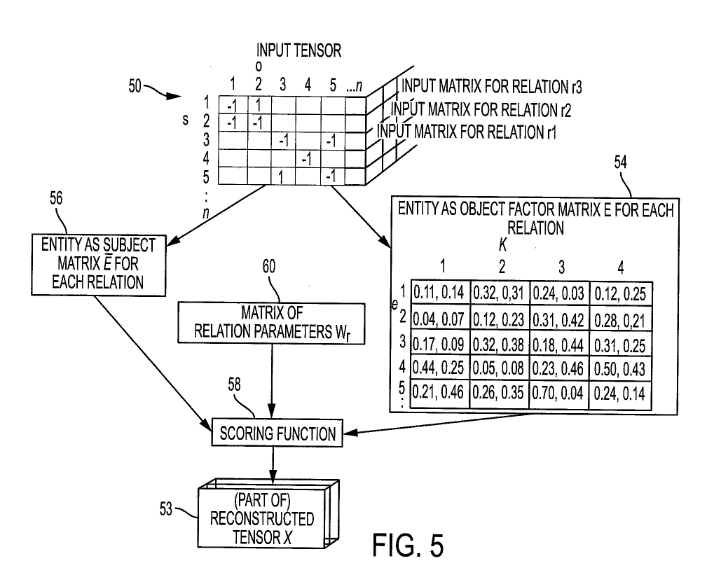

The illustrated software instructions 14 include a matrix generation component 36, a matrix completion component 38, a prediction component 40, and an output component 42. The matrix generation component 36 draws a training set 44 of positive example relations from the relations KB 22 and uses them to generate an input matrix 46 for each of a set R 48 of relations r of interest. The set of relations may include a single relation or at least two relations, such as at least three, or at least five, or at least ten relations. The matrices for two or more relation-types may be composed as a three-dimensional tensor. Each entry in the input matrix 46 corresponds to a subject entity, object entity pair and is either unknown (and may be set to 0), or is a binary value indicating whether the relation holds for the subject and object entities in the relation (+1) or not (−1). Each input matrix may be fairly sparse. An example input matrix 46 for an antisymmetric relation (e.g., wasBornIn) is illustrated in FIG. 4. A corresponding tensor 50 (stack of matrices 46) for a set of two or more relations is shown in FIG. 5. As will be appreciated, in practice the input matrices 46 may each include many more elements.

The matrix completion component 38 generates a reconstructed matrix X 52 (FIG. 4) or tensor 53 composed of a stack of matrices (FIG. 5), which approximate(s) the input matrix(es), but in which each element has a predicted score. This is achieved by decomposing the input matrix 46 into low rank matrices 54, 56 so as to minimize an overall error between the reconstructed matrix 52 and the input matrix 50. The reconstructed matrix 52 corresponds to the composition of the low rank matrixes 54, 56 using a scoring function 58 which also takes into account parameters 60 of the relation(s). The elements in the low rank matrices 54, 56 are all complex numbers, thus each row of a low rank matrix 54, 56 corresponds to a complex-valued vector. The relation parameters include a vector of complex numbers, for each relation. The rank of the low rank matrix 54, 56 is K, which is the number of columns of the matrix. Each row of matrix 54 corresponds to one of the entities. The latent values in this matrix correspond to the case where the entity is serving as a subject in a relation. In the exemplary embodiment, the values in low rank matrix 56 are the complex conjugate of the latent values in matrix 54 and are used when the entity serves as an object in a relation. It is not necessary to store the matrix 56 in memory; its values can be computed when needed from the matrix 54.

The prediction component 40 uses the scoring function parameters, or a part thereof, to make a prediction. For example, given an input query 70, such as in what town did Abraham Lincoln go to school, the prediction component 44 determines a predicted (or true value) for a relation of the form Lincoln studiedIn?. If there is no entry which is true (i.e., 1), the row of the reconstructed matrix 52 for the relation studiedIn is computed and the object entity with the highest predicted score for the subject entity Lincoln is identified. The identified object entity 72, and/or other information generated based thereon, may be output by the output component 42.

As will be appreciated, it is generally not necessary to compute the entire matrix 52, but only the relevant row from the rows of the matrices 54, 56 corresponding to the query. In particular, the scores for a query are computed on the fly using the corresponding entity and relation parameters, i.e., corresponding rows in the entities and relations matrices (and applying the conjugate on the object row). The effective output of the algorithm can thus be the entities and relations matrices, that can be combined to score the likelihood of any relation between any two entities.

FIG. 2 illustrates a method for link prediction which may be performed with the system of FIG. 1. The method begins at S100.

At S102, a set of training samples 44 for one or more relations is generated. This may include retrieving a set of positive training samples from the relations database for each of a set of relations, each positive training sample including a subject entity and an object entity that are in the relation (i.e., the relation is met (true) for this pair of entities). One or more negative training examples may be automatically generated for each positive training sample, for which the relation is likely not met for the pair of entities.

At S104, for each relation type, an input matrix 46 is generated, by the matrix generation component 36, using the set of training samples 44.

At S106, for each relation type, parameters of a scoring function 58 for generating a reconstructed matrix 52 are learned from the input matrix 46, by the matrix completion component 38. The parameters of the scoring function may be stored in memory or output from the system, e.g., to a client device which will make use of (parts of) the prediction matrix 52 generated therefrom.

At S108, a query is received and may be used, at S110 by the prediction component 40, to compute a predicted entity 62 of the reconstructed prediction matrix 52 that is responsive to the query. For example, a query may be generated for identifying the probable object of a given relation where the subject is known (or vice versa) and may be used to compute a relevant row of the appropriate prediction matrix 52 to receive the object entity with the highest probability (or a set of n most probable object entities).

At S112, the object entity 62 identified at S110, and/or other information generated based thereon, may be output by the output component 46.

The method ends at S114.

S106 of the method may include the following substeps, as illustrated in FIG. 3:

At S200, parameters 62 of a scoring function 58 are initialized (e.g., randomly). The parameters 62 include the real and imaginary values of the latent factors of matrices 54, 56 and relation parameters 60.

At S202, the parameters 62 are progressively adjusted to minimize the error between input matrix(es) 44 and reconstructed matrix(es) 52, e.g., using gradient descent.

At S204, optionally, a prediction matrix may be generated by replacing the elements of the reconstructed matrix(es) 52 that had a value of 1 in the input matrix with their original value of 1.

At S206 the learned parameters 62 of the scoring function and/or prediction matrix 52 are stored and/or output.

The method illustrated in FIGS. 2 and 3 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other non-transitory medium from which a computer can read and use. The computer program product may be integral with the computer 30, (for example, an internal hard drive of RAM), or may be separate (for example, an external hard drive operatively connected with the computer 30), or may be separate and accessed via a digital data network such as a local area network (LAN) or the Internet (for example, as a redundant array of inexpensive or independent disks (RAID) or other network server storage that is indirectly accessed by the computer 30, via a digital network).

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphics card CPU (GPU), or PAL, or the like. In general, any device, capable of implementing a finite state machine that is in turn capable of implementing the flowchart shown in FIG. 2 and/or 3, can be used to implement the method for link prediction. As will be appreciated, while the steps of the method may all be computer implemented, in some embodiments one or more of the steps may be at least partially performed manually. As will also be appreciated, the steps of the method need not all proceed in the order illustrated and fewer, more, or different steps may be performed.

Further details on the system and method will now be described.

In the following, the terms “optimization,” “minimization,” and similar phraseology are to be broadly construed as one of ordinary skill in the art would understand these terms. For example, these terms are not to be construed as being limited to the absolute global optimum value, absolute global minimum, and so forth. For example, minimization of a function may employ an iterative minimization algorithm that terminates at a stopping criterion before an absolute minimum is reached. It is also contemplated for the optimum or minimum value to be a local optimum or local minimum value.

The dot product between embeddings (here, the vectors of the low rank matrices 54, 56 and relation parameters 60) can be a very effective composition function for composing the reconstructed matrix 52, when using representations that are a complex embeddings, rather than embeddings containing real numbers. When using complex vectors, i.e., vectors with entries in [symbol] , the dot product is often called the Hermitian (or sesquilinear) dot product, as it involves the conjugate-transpose (the Hermitian form) of one of the two vectors. As a consequence, the dot product is not symmetric and facts about antisymmetric relations can receive different scores, depending on the ordering of the entities involved. Thus complex vectors can effectively capture antisymmetric relations while retaining the efficiency benefits of the dot product, that is linear in both memory and time complexity.

First, the use of complex embeddings in the square matrix case is described. In this case, there is only a single relationr between entities being considered. The formulation is then extended to a stacked set of square matrices 50 in a third-order tensor to represent multiple relations. Experiments performed on large scale public benchmark KBs show that this representation leads not only to simpler and faster algorithms, but also gives a systematic accuracy improvement over current alternatives.

### Relations as Low-Rank Normal Matrices

Complex embeddings will first be described for low-rank matrix factorization. To illustrate this method, a simplified link prediction task with merely a single relation type is considered.

Understanding the factorization in the complex space leads to a better theoretical understanding of the class of matrices that can be approximated by dot products of embeddings. These are the so-called normal matrices for which the left and the right embeddings share the same orthogonal basis.

1. Modelling Relations

Given a set of entities ε, as noted above, a relation between subject s and object o entities is represented as a binary value Yₛₒ ε {−1,1}. The probability that the relation has a value of 1 (true) is given by a logistic inverse link function:

P(Yₛₒ=1)=σ(Xₛₒ) (1)

where X ε [symbol] ^{n×n} is a latent matrix 52 of scores and a is a sigmoid function which outputs values of from 0-1.

The aim is to find a generic structure for the reconstructed matrix X that leads to a flexible approximation of common relations in real world KBs. Standard matrix factorization approximates X by a matrix product UV^{T}, where U and V are two functionally independent n×K matrices (here, matrices 54, 56), K being the rank of the matrix. Within this formulation it is assumed that entities appearing as subjects are different from entities appearing as objects. This means that the same entity will have two different embedding vectors, depending on whether it appears as the subject or the object of a relation. This extensively studied type of model is closely related to the singular value decomposition (SVD) and fits well to the case where the matrix X is rectangular. However, in many link prediction problems, the same entity can appear as both subject and object. Accordingly, joint embeddings of the entities are learnt. The embeddings of the left and right factors can be shared to solve the link prediction problem. Similar approaches are described in Nickel 2011, Bordes 2013a, and Yang 2015.

In order to use the same embedding for subjects and objects, the notion of dot products can be extended to scoring functions (also known as composition functions), that combine embeddings in specific ways. Several illustrative examples of scoring functions are shown in Table 1, together with a scoring function for an exemplary method (denoted Complex) described herein.

TABLE 1
Scoring functions of some existing latent factor models for a given fact r(s, o),
along with their relation parameters, and time and space (memory) complexity

| | | Relation | | |
|---|---|---|---|---|
| Model | Scoring Function | parameters | [symbol] ₜᵢₘₑ | [symbol] _{space} |
| RESCAL | eₛ^{T}Mᵣeₒ | Mᵣ ε [symbol] ^{K}^{²} | [symbol] (K²) | [symbol] (K²) |
| (Nickel | | | | |
| 2011) | | | | |
| TransE | ∥(eₛ + wᵣ) − eₒ∥ₚ | wᵣ ε [symbol] ^{K} | [symbol] (K) | [symbol] (K) |
| (Bordes | | | | |
| 2013a) | | | | |
| NTN (Socher 2013) | ${u}_{r}^{T} f ( \begin{matrix}{e}_{s} {W}_{r}^{[ 1 … D ]} {e}_{o} + \\ {V}_{r} [ \begin{matrix}{e}_{s} \\ {e}_{so}\end{matrix} ] {b}_{r}\end{matrix} )$ | Wᵣ ε [symbol] ^{K}^{²}^{D}, Vᵣ ε [symbol] bᵣ, uᵣ ε [symbol] ^{K} | [symbol] (K²D) | [symbol] (K²D) |
| DistMult | <wᵣ, eₛ, eₒ> | wᵣ ε [symbol] ^{K} | [symbol] (K) | [symbol] (K) |
| (Yang | | | | |
| 2015) | | | | |
| HolE | wᵣ^{T}( [symbol] ⁻¹[ [symbol] [eₛ] ⊙ [symbol] [eₒ]]) | wᵣ ε [symbol] ^{K} | [symbol] (Klog(K) | [symbol] (K) |
| (Nickel | | | | |
| 2015b) | | | | |
| Complex | Re(<wᵣ, ēₛ, eₒ>) | wᵣ ε [symbol] ^{K} | [symbol] (K) | [symbol] (K) |

[symbol]

indicates data missing or illegible when filed

The embeddings e_{S} and e_{O} 54, 56 of subject s and object o are in [symbol] ^{K} for all models, except for the exemplary model (Complex), where eₛ, eₒ ε [symbol] ^{K}, where [symbol] denotes a complex number, and [symbol] ^{K} indicates that the embeddings are complex-valued vectors of K dimensions. D is an additional latent dimension of the NTN model. [symbol] and [symbol] ⁻¹ denote respectively the Fourier transform and its inverse, and ⊙ is the element-wise product between two vectors. Re( [symbol] wᵣ, ēₛ, eₒ [symbol] ) denotes that the score is a real value Re, which is a function of the embedding of the relation, wᵣ, the embedding of the object entity eₒ, and the embedding of the complex conjugate of the subject entity eₛ (indicated by the bar on top). In the case of Re( [symbol] wᵣ, ēₛ, eₒ [symbol] ), [symbol] wᵣ, ēₛ, eₒ [symbol] denotes the dot product of the three parameters, and is a scalar, real value (the imaginary component being ignored). The complex conjugate of a complex number has an identical real part while the imaginary part is of equal magnitude but of opposite sign.

Using the same embeddings for right and left factors can be reduced to an Eigenvalue decomposition:

X=UDU⁻¹ (2)

This decomposition is often used to approximate real symmetric matrices such as covariance matrices, kernel functions and distance or similarity matrices. In these cases all eigenvalues and eigenvectors live in the real space and U is unitary: U^{T}=U⁻¹. However, in the exemplary embodiment, it is desirable to be able to consider the case where matrices (and thus the relations they represent) can also be antisymmetric. In that case, eigenvalue decomposition is not possible in the real space, and there only exists a decomposition in the complex space, where embeddings x ε [symbol] ^{K} are the sum of a real vector component Re(x) and an imaginary vector component Im(x). With complex numbers, the dot product, also called the Hermitian product, or sesquilinear form, is defined as:

[symbol]

u, v [symbol] :=ū^{T}v (3)

where u and v are complex-valued vectors, i.e., u=Re(u)+iIm(u), where Re(u)ε [symbol] ^{K} and Im(u)ε [symbol] ^{K} correspond to the real and imaginary parts of the vector u ε [symbol] ^{K}, and i is the square root of −1. In computing the Hermitian product, one operation to be performed is thus to take the conjugate of the first vector: ū=Re(u)−iIm(u). Use of the Hermitian product when composing complex vectors can be justified on the basis that it gives a valid topological norm in the induced vectorial space. For example, x̅^{T}x=0 implies x=0 while this is not the case for the bilinear form x^{T}x as there are many complex vectors for which x^{T}x=0.

Even with complex eigenvectors U ε [symbol] ^{n×K}, the inversion of U in the eigen decomposition of Equation (2) leads to computational issues. To avoid inverting the eigenvector matrix, an appropriate class of matrices can be considered. In particular, the space of normal matrices is considered, i.e., the n×n matrices X, such that XX^{T}=X^{T}X. This space includes all symmetric and antisymmetric binary matrices (useful to model hierarchical relations such as IsOlder), as well as all orthogonal matrices (including permutation matrices), and many other matrices that are useful to represent binary relations, such as assignment matrices that represent bipartite graphs. The matrices that are not normal are related to triangular matrices. These can be handled through non-linearities of the logistic function. It is to be noted that while there are many binary matrices Y that have a triangular shape, this does not imply that the matrix X is triangular, as shown by Bouchard 2015, through the use of the sigmoid link from Equation (1). The spectral theorem for normal matrices states that for every normal matrix X, the following decomposition exists:

X=ŪDU (4)

where D ε [symbol] ^{n×n} is the diagonal matrix of eigenvalues (with decreasing module) and U ε [symbol] ^{n×n} is a unitary matrix of eigenvectors, with Ū representing its complex conjugate. The complex embedding matrix can then be defined by rescaling the columns of U through E=U\sqrt{D}, leading to:

X=ĒE^{T} (5)

In this last factorization, row and column representations are conjugate to each other.

Compared to the singular value decomposition, the eigenvalue decomposition has two key differences:

1. The eigenvalues are not necessarily positive or real;

2. The factorization of Eqn. (5) is very useful as the rows of E can be used as vectorial representations of the entities corresponding to rows and columns of the relation matrix X. Indeed, for a given entity, its subject embedding vector is the complex conjugate of its object embedding vector.

### 2 Low-Rank Normal Matrices

In the link prediction method, the matrix X 52 is unknown and the goal is to recover it from noisy observations.

Assuming that the relation matrix X is normal allows describing the relations used in most KBs. It can also be assumed that there is a sufficient degree of regularity in the observations to be able to generalize to unobserved links as well. In other words, it is assumed that the relation matrix has a low rank. This is a reasonable assumption, since the rank is a natural measure of complexity for matrices, which can be empirically confirmed by the wide success of factorization models (Nickel 2015a). In such a case, only the first K values of diag(D) are non-zero, with K<<n.

By imposing a low-rank structure on the normal matrix X, the decomposition of the normal matrix can be written as X=ĒE^{T}, where the factor matrix E has a small number of columns. This is equivalent to considering that individual relations Xₛₒ between entities s and o can be predicted through the Hermitian (or sesquilinear) dot product of their embeddings eₛ ε [symbol] ^{K} and eₒ ε [symbol] ^{K}:

$$\begin{matrix}〈 {e}_{s} , {e}_{o} 〉 = {\sum }_{k = 1}^{K} {\overline{e}}_{sk} {e}_{ok} \\ = 〈 Re ( {e}_{s} ) , Re ( {e}_{o} ) 〉 + 〈 Im ( {e}_{s} ) , Im ( {e}_{o} ) 〉 \\ + i 〈 Re ( {e}_{s} ) , Im ( {e}_{o} ) 〉 - 〈 Im ( {e}_{s} ) , Re ( {e}_{o} ) 〉\end{matrix} \qquad ( 6 )$$

The model given in Eq. (1) can now be slightly modified to obtain a real number in the scoring function:

P(Yₛₒ₌₁)=σ(w′Re(Xₛₒ)+w″Im(Xₛₒ)) (7)

where Xₛₒ= [symbol] eₛ, eₒ [symbol] , σ is a sigmoid function, and where w′ and w″ are real numbers that are jointly learned with the latent representations 54, 56. The sesquilinear property projected on the real space enables an accurate description of both symmetric and asymmetric relations between pairs of entities, while still using joint representations of entities, whether they appear as subject or object of relations. Indeed, [symbol] eₛ, eₒ [symbol] = [symbol] eₛ, eₒ [symbol] , meaning that Re(eₛ, eₒ) is symmetric, while Im [symbol] eₛ, eₒ [symbol] is antisymmetric.

Advantages of this approach include the following:

1. The class of low-rank normal matrices encompasses most real-world binary relations, i.e., relations found in current KBs.

2. These relations can be efficiently approximated by a simple low-rank factorization, using complex numbers to represent the latent factors.

3. This factorization enables accurately description of both symmetric and antisymmetric relations.

3. Application to Binary Multi-Relational Data

The above description focuses on modeling a single type r of relations. This model can be extended to multiple types of relations by introducing a complex relation embedding vector and by sharing the entity embeddings across all relations.

Given a set [symbol] of relations and a set of entities present in the KB 22, the aim is to recover matrices of scores Xᵣ for all the relations r ε [symbol] . Given two entities s and o ε ε, the log-odd of the probability that the fact r(s, o) is true is:

P(Yᵣₛₒ=1)=σ(φ(r, s, o; Θ)) (8)

where σ is a sigmoid function, φ is a scoring function that is based on the factorization of the observed relations, and Θ represents the parameters of the scoring function. While X 52 as a whole is unknown, it is assumed that a set of true and false facts {Yᵣₛₒ}_{r(s,o)ε Ω} ε{−1,1}^{″Ω|} are observed in the knowledge base 22, corresponding to the partially observed adjacency matrices of the relations, where Ω ⊂ [symbol] [symbol] ε [symbol] ε is the set of observed triples in the training set 44. The goal is to find the probability of an entry Y_{r′s′o′} to be true or false, for a set of targeted unobserved triples r′(s′, o′)∉ Ω.

Depending on the scoring function φ(r, s, o; Θ) used to predict the entries of the three dimensional tensor X 53, different models are obtained. Examples of scoring functions were given in Table 1. Compared to the symmetric dot product model (DistMult), the sesquilinear form can be obtained by using the complex conjugate for the subject entity, as defined in the Hermitian product (Eq. 6):

$$\begin{matrix}φ ( r , s , o ; Θ ) = Re ( 〈 {w}_{r} , {\overline{e}}_{s} , {e}_{o} 〉 ) & ( 9 ) \\ = Re ( {\sum }_{k = 1}^{K} {w}_{rk} , {\overline{e}}_{sk} , {e}_{ok} ) & ( 10 ) \\ = 〈 Re ( {w}_{r} ) , Re ( {e}_{s} ) Re ( {e}_{o} ) 〉 \\ + 〈 Re ( {w}_{r} ) , Im ( {e}_{s} ) Im ( {e}_{o} ) 〉 \\ - 〈 Im ( {w}_{r} ) , Re ( {e}_{s} ) Im ( {e}_{o} ) 〉 \\ + 〈 Im ( {w}_{r} ) , Im ( {e}_{s} ) Re ( {e}_{o} ) 〉 & ( 11 )\end{matrix}$$

where the relation embedding wᵣ is a complex vector. Thus, for example, to compute [symbol] Re(wᵣ), Re(eₛ), Re(eₒ) [symbol] , the three kth values of the three real value vectors Re(wᵣ), Re(eₛ) and Re(eₒ) are multiplied together and the k scalar values thus produced are then summed.

These equations provide two useful views of the model:

1. Changing the representation: Equation (9) would correspond to the Distmult model with real embeddings, but handles asymmetry due to the complex conjugate of one of the embeddings. Note that in Equation (9) the standard component wise multi-linear dot product (a, b, c):=Σₖ aₖbₖcₖ can be used rather than the Hermitian product.

2. Changing the scoring function: Equation (11) only involves real vectors corresponding to the real and imaginary parts of the embeddings and relations. The representation of entities as pairs of real embeddings involves parameter sharing between the subject and object embeddings.

It can be seen that this function is antisymmetric when w is purely imaginary (i.e., its real part is zero), and symmetric when w is real. Conveniently, by separating the real and imaginary parts of the relation embedding wᵣ, a decomposition of the relation matrix X is obtained as the sum of a symmetric matrix Re(Ē^{T} diag (Re(wᵣ))E) and an antisymmetric matrix Im(Ē^{T} diag (Im(wᵣ))E).

The completion of the reconstructed tensor X 52 may involve minimization of a loss function which combines a reconstruction error over the training set and regularization terms. For example, the parameters Θ of the scoring function model φ(s, r, o; Θ) can be learned by minimizing the negative log-likelihood of the logistic loss with L₂ regularization on the parameters Θ of the considered model:

$$\begin{matrix}min \\ Θ\end{matrix} {\sum }_{r ( s , o ) Ω} log ( 1 + exp ( - {Y}_{rso} φ ( s , r , o ; Θ ) ) ) + λ {‖ Θ ‖}_{2}^{2} \qquad ( 12 )$$

The parameters θ correspond to the embeddings eₛ, wᵣ, eₒ ε [symbol] ^{K}.

λ∥Θ∥₂² is a regularization parameter. A suitable value of λ can be learned by cross validation.

The minimization of the loss function can be solved by gradient descent. For example, Stochastic Gradient Descent can be used to identify the optimum set of parameters, e.g., with mini-batches of training samples. The learning rate may be constant or varied. For example, the AdaGrad method for tuning the learning rate may be used (Duchi, John, et al., “Adaptive Subgradient Methods for Online Learning and Stochastic Optimization,” Technical Report UCB/EECS-2010-24, EECS Department, University of California, Berkeley, March 2010). In this method, the aim is to minimize the difference between the reconstructed values in the reconstructed matrix and the corresponding true values (+1 or −1) in the input matrix by iterative adjustments to the parameters (latent factors and w) of the scoring function and in the case of more than one relation, jointly learning the parameters, e.g., using Eqn. (12). The gradient descent may be stopped at a selected stopping point, e.g., after a predetermined number of iterations, or when there is no further improvement in the error, e.g., according to Eqn. (12).

An exemplary method for matrix and tensor factorization for link prediction data has been described herein that uses vectors with complex values and retains the mathematical definition of the dot product. This leads to characterizing the class of matrices that can efficiently be approximated by the model, namely low-rank normal matrices, with significant improvements over existing systems.

The method finds use, for example, in a system employing virtual (or real) agents to answer queries. The agent accesses a database with an input query and if the database does not include the relation, may use the present method to predict the relation. The system and method may also find application in recommendations for a user. In this case, the input matrix includes users as subject entities and items, such as products or services, as object entities. Values in the input matrix correspond to user ratings for the items.

Various extension of the method are also contemplated:

In one embodiment, the exemplary method is combined with other types of extensions to tensor factorization in order to further improve predictive performances. For example, the use of pairwise embeddings together with complex numbers may lead to improved results in many situations that involve non-compositionality, i.e., pairs of entities that often appear together.

In another embodiment, a negative sampling procedure is used which chooses more informative negative training samples for the positive training sample from which they have been sampled. This would reduce the number of negatives required to reach good performance, thus accelerating training time.

Without intending to limit the scope of the exemplary embodiment, the following Examples illustrate the method.

### EXAMPLES

In order to evaluate the method, experiments were conducted on both synthetic and real datasets. The synthetic dataset is based on relations that are either symmetric or antisymmetric, whereas the real datasets comprise different types of relations found in different, standard KBs.

### 4.1 Synthetic Task

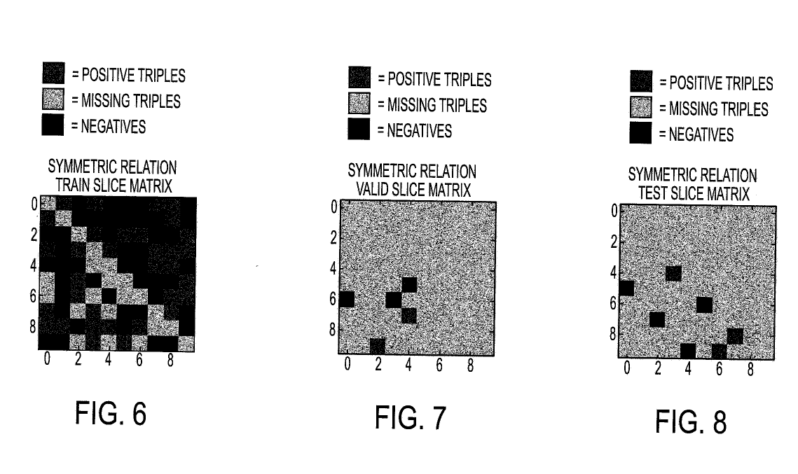

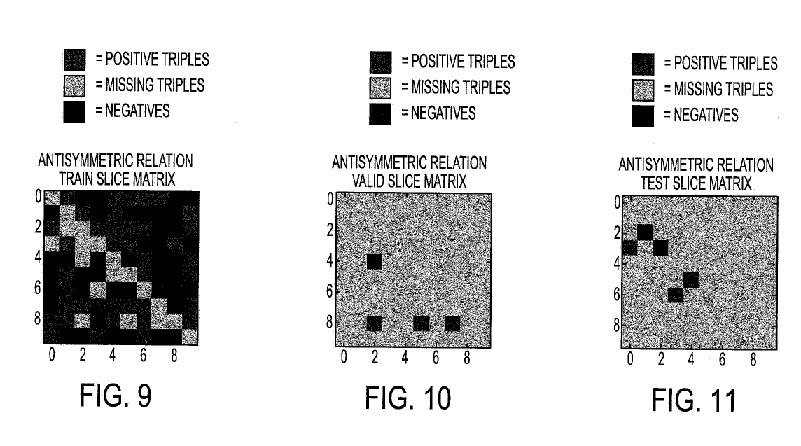

To assess the ability of method to accurately model symmetry and antisymmetry, a KB of two relations and 30 entities was randomly generated. One relation is entirely symmetric, while the other is completely antisymmetric. This dataset corresponds to a 2×30×30 tensor 50. FIGS. 6-11 show a slice of this randomly generated tensor, for a symmetric relation (FIGS. 6-8) and an antisymmetric relation (FIGS. 9-11) for the first 10 entities, in each case, decomposed into training, validation and test sets. The diagonal is unobserved as it is not relevant in this experiment.

The training set contains 1566 observed triples, whereas the validation and test sets contain 196 triples each.

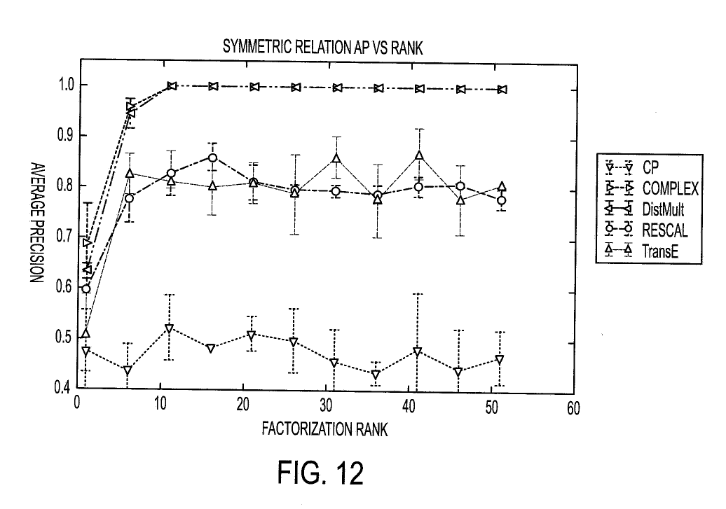

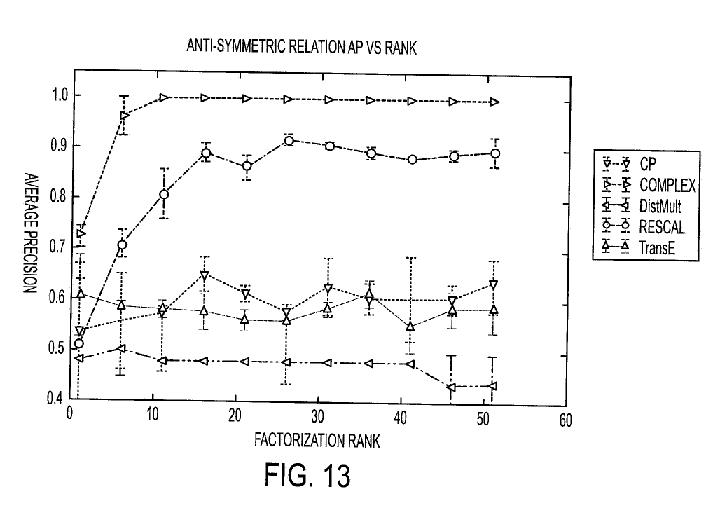

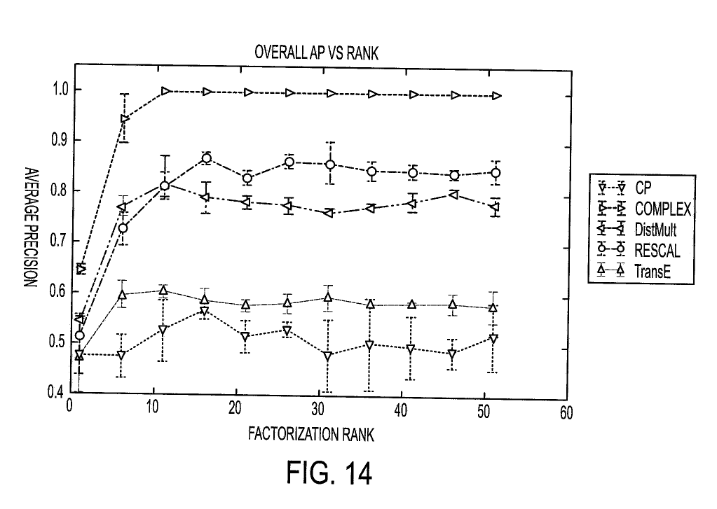

FIGS. 12-14 show the best cross-validated Average Precision (area under Precision-Recall curve) for different factorization models of ranks ranging up to 50, including the exemplary Complex model. Models were trained using Stochastic Gradient Descent with mini-batches and AdaGrad for tuning the learning rate (Duchi, John, et al., “Adaptive Subgradient Methods for Online Learning and Stochastic Optimization,” Technical Report UCB/EECS-2010-24, EECS Department, University of California, Berkeley, March 2010), by minimizing the negative log-likelihood of the logistic loss with L₂ regularization on the parameters Θ of the considered model:

$$\begin{matrix}min \\ Θ\end{matrix} {\sum }_{r ( s , o ) Ω} log ( 1 + exp ( - {Y}_{rso} φ ( s , r , o ; Θ ) ) ) + λ {‖ Θ ‖}_{2}^{2} \qquad ( 12 )$$

In the present Complex model, the parameters Θ correspond to eₛ, wᵣ, eₒ ε [symbol] ^{K}.

λ is validated in {0.1, 0.03, 0.01, 0.003, 0.001, 0.0003, 0.00001, 0.0}.

The results show that the DistMult model (Yang 2015) is not able to model antisymmetry and only predicts the symmetric relations correctly. Although the TransE model (Bordes 2013a) is not a symmetric model, it performs poorly in practice, particularly on the antisymmetric relation. The RESCAL model (Nickel 2011; Riedel 2013), with its large number of parameters, quickly overfits as the rank grows. The Canonical Polyadic (CP) decomposition (Hitchcock, F L., “The expression of a tensor or a polyadic as a sum of products,” J. Math. Phys, 6(1):164-189, 1927) fails on both relations as it has to push symmetric and antisymmetric patterns through the entity embeddings. Even on such simple data, only the present Complex model performs well overall.

### 4.2 Real Datasets: FB15K and WN18

The performance of the Complex model on the FB15K and WN18 datasets is evaluated. FB15K is a subset of Freebase, a curated KB of general facts, whereas WN18 is a subset of Wordnet, a database featuring lexical relations between words. The original training, validation and test splits provided by Bordes 2013a are used in the evaluation. Table 2 summarizes the metadata of the two datasets.

TABLE 2
Number of entities, relations, and observed triples
in each split for the FB15K and WN18 datasets

| Dataset | \| [symbol] \| | \| [symbol] \| | #triples in Training/Validation/Test |
|---|---|---|---|
| WN18 | 40,943 | 18 | 141,442/5,000/5,000 |
| FB15K | 14,951 | 1,345 | 483,142/50,000/59,071 |

Both datasets contain only positives triples. Similar to Bordes 2013a, negatives were generated using the local closed world assumption. That is, for a triple, either the subject or the object is randomly changed, so as to form a negative example. This negative sampling is performed at runtime for each batch of positive training examples.

For evaluation, the quality of the ranking of each test triple among all possible subject and object substitutions, r(s′, o) and r(s, o′), ∀s′, ∀o′ ε ε, is measured: Mean Reciprocal Rank (MRR) and Hits at n are the standard evaluation measures for these datasets and can be raw or filtered (Bordes, 2013a). The filtered metrics are computed after removing all the other observed triples that appear in the training, validation or test set from the ranking, whereas the raw metrics do not remove them.

Pairwise ranking losses are often used as ranking measures for this type of task. However, in these examples, the negative log likelihood of the logistic loss was selected, as it has been shown to learn compact representations for several relations, especially for transitive relations (Bouchard, Guillaume, et al., “Theo. On approximate reasoning capabilities of low-rank vector spaces,” AAAI Spring Symp. on Knowledge Representation and Reasoning (KRR): Integrating Symbolic and Neural Approaches, 2015).

Both filtered and raw MRRs, and filtered Hits at 1, 3 and 10 are shown in Table 3 for the evaluated models. The TransE, DistMult and HolE models were selected as baselines since they are considered the best performing models on those datasets (Nickel 2015b, Yang 2015). For experimental comparison, these methods were implemented within the same framework as the exemplary complex embedding model. The Downhill package (https://github.com/lmjohns3/downhill), which provides algorithms for minimizing scalar loss functions with stochastic gradient descent (SGD) that are defined using the Theano based SGD package (Bergstra, James, et al., “Theano: a CPU and GPU math expression compiler,” Proc. of the Python for Scientific Computing Conf. (SciPy), pp. 1-7 (2010)) were used. However, due to the complexity of an efficient implementation of the HolE model, the original results for the HolE as reported in Nickel 2015b are reported. Hits@n metrics are filtered.

TABLE 2
Filtered and Raw Mean Reciprocal Rank (MRR) for the tested models
on FB15K and WN18 datasets

| | WN18 | | | | | FB15K | | | | |
|---|---|---|---|---|---|---|---|---|---|---|
| | MRR | | Hits at | | | MRR | | Hits at | | |
| Model | Filter | Raw | 1 | 3 | 10 | Filter | Raw | 1 | 3 | 10 |
| TransE | 0.454 | 0.335 | 0.089 | 0.823 | 0.934 | 0.282 | 0.193 | 0.177 | 0.330 | 0.473 |
| DistMult | 0.822 | 0.532 | 0.728 | 0.914 | 0.936 | 0.654 | 0.242 | 0.546 | 0.733 | 0.824 |
| HolE* | 0.938 | 0.616 | 0.93 | 0.945 | 0.949 | 0.524 | 0.232 | 0.402 | 0.613 | 0.739 |
| Complex | 0.941 | 0.587 | 0.936 | 0.945 | 0.947 | 0.692 | 0.242 | 0.599 | 0.759 | 0.840 |

### 4.3 Results

The WN18 dataset describes lexical hierarchies between words, and contains many antisymmetric relations, such as hypernymy, hyponymy, or being “part of.” This results in the DistMult and TransE models being outperformed by Complex and HolE, which are comparable on this dataset, with respective filtered MRR of 0.941 and 0.938.

The results shown in Table 4 are given for the best set of hyper-parameters evaluated on validation sets, for each model, after grid search on the following values:

K ε {10,20,50,100,150,200},

λ ε {0.1,0.03,0.01,0.003,0.001,0.0003,0.00001,0.0},

α₀ ε {1.0,0.5,0.2,0.1,0.05,0.02,0.01},

η ε {1,2,5,10};

with λ the L₂ regularization parameter, α₀ the initial learning rate (then tuned at runtime with the AdaGrad method for learning rate adaptation), and η the number of negatives generated per positive training triple. Varying the batch size was also evaluated, but this had no impact and 100 batches per epoch was selected. Best ranks K were generally 150 or 200. The number of negative samples per positive sample also had a significant influence on the filtered MRR on the FB15K dataset (up to +0.08 improvement from 1 to 10 negatives), but not much impact on the WN18 dataset. On both datasets, regularization had an impact (up to +0.05 on filtered MRR between λ=0 and the optimal λ). The initial learning rate had a significant impact on the FB15K dataset, while a lesser effect was observed on WN18. This may partly explain why the results obtained for the DistMult model were better than those previously reported by Yang 2015, together with the use of the log-likelihood objective. The AdaGrad method is relatively insensitive to the initial learning rate, perhaps leading to overconfidence in its ability to tune its step size online, and consequently leading to less careful tuning of the initial step size. TransE results however are consistent with those reported in Nickel 2015b, Bordes 2013a. Training was stopped using early stopping on the validation set filtered MRR, computed every 50 epochs, with a maximum of 1000 epochs.

Table 4 shows the test filtered MRRs for the considered models for each relation of WN18, confirming the advantage of the Complex model on antisymmetric relations while losing nothing on almost all the other ones.

TABLE 4
Filtered Mean Reciprocal Rank (MRR) for the models tested
on each relation of the Wordnet dataset (WN18)

| Relation name | Complex | DistMult | TransE |
|---|---|---|---|
| member_of_domain_topic | 0.924 | 0.914 | 0.861 |
| member_meronym | 0.921 | 0.704 | 0.418 |
| derivationally_related_form | 0.946 | 0.940 | 0.384 |
| member_of_domain_region | 0.865 | 0.635 | 0.865 |
| similar_to | 1.000 | 1.000 | 0.244 |
| hypernym | 0.953 | 0.791 | 0.446 |
| member_holonym | 0.946 | 0.740 | 0.465 |
| instance_hypernym | 0.965 | 0.943 | 0.961 |
| member_of_domain_usage | 0.917 | 0.917 | 0.875 |
| synset_domain_topic_of | 0.930 | 0.919 | 0.917 |
| hyponym | 0.946 | 0.710 | 0.361 |
| instance_hyponym | 0.945 | 0.940 | 0.745 |
| synset_domain_usage_of | 1.000 | 1.000 | 1.000 |
| has_part | 0.933 | 0.753 | 0.426 |
| verb_group | 0.936 | 0.897 | 0.323 |
| part_of | 0.940 | 0.867 | 0.455 |
| synset_domain_region_of | 0.919 | 0.888 | 0.986 |
| also_see | 0.603 | 0.607 | 0.279 |

On the FB15K dataset, the gap is much larger and the Complex model largely outperforms the HolE model, with a filtered MRR of 0.692 and 59.9% of Hits at 1, compared to 0.524 and 40.2% for HolE. This may be attributed to the simplicity of the Complex model. TransE is largely outperformed on both datasets.

### 4.4 Influence of Negative Samples

The influence of the number of negatives generated per positive training sample was further investigated. In the previous experiment, due to computational limitations, the number of negatives per training sample, η, was validated from among the possible numbers {1,2,5,10}. This experiment aims to evaluate whether increasing these numbers could lead to better results. To do so, the FB15K dataset, with the best validated λ,K,α₀, obtained from the previous experiment, were used. η was varied in {1,2,5,10,20,50,100,200}.

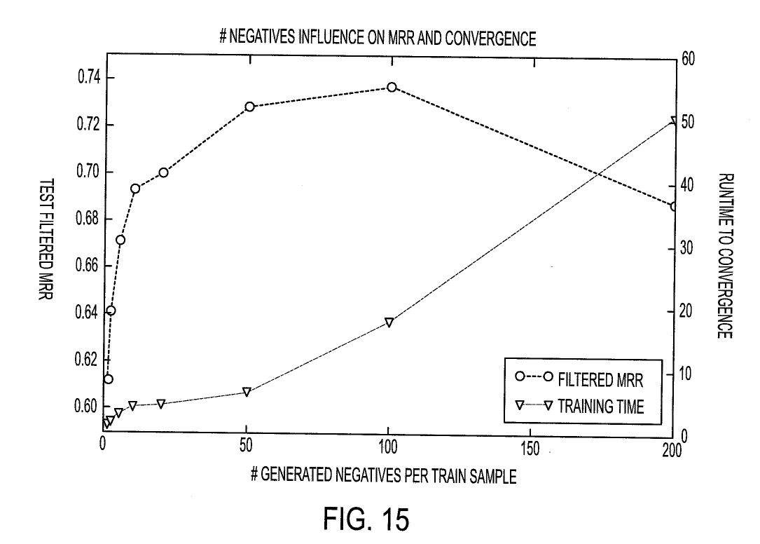

FIG. 15 graphically illustrates the influence of the number of negative triples generated per positive training example, on the test filtered MRR and on the training time to convergence on the FB15K dataset, for the Complex model with K=200, λ=0.01 and α₀=0.5. Times are given relatively to the training time with one negative triple generated per positive training sample (=1 on time scale).

Generating more negatives clearly improves the results, with a filtered MRR of 0.737 with 100 negative triples, before decreasing again with 200 negatives. The model also converges with less epochs, which compensates partially for the additional training time per epoch, up to 50 negatives. It then grows linearly as the number of negatives increases. From these results, it appears that 50 negative triples provides the best trade-off between accuracy and training time.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for link prediction comprising:
providing training samples for at least one relation, the training samples comprising positive training samples in which a first of a set of entities is a subject in the relation and a second of the set of entities is an object in the relation;
generating an input matrix for each of the at least one relation, based on the training samples;
with a processor, learning parameters of a scoring function which minimize an error between a reconstructed matrix and the input matrix, the parameters including a set of latent factors for each entity, each of the latent factors being a complex number;
performing at least one of:
outputting the parameters of the scoring function for performing link prediction; and
predicting an entity for a relation based on the parameters.

2. The method of claim 1, wherein the at least one relation comprises a plurality of relations.

3. The method of claim 2, where in the input matrices are composed as a three dimensional tensor.

4. The method of claim 1 wherein the at least one relation comprises an asymmetric relation.

5. The method of claim 1, wherein the parameters include parameters of the relation for each of the at least one relation, the relation parameters comprising a complex number.

6. The method of claim 5, wherein the scoring function computes a Hermitian dot product of the latent factors for a first entity, the complex conjugates of the latent factors for a second entity, and the parameters of the relation.

7. The method of claim 1, wherein for each pair of entities in the input matrix, the scoring function computes a sum, over all the latent factors, of the product of the relation embedding, and the latent factors of the respective entities.

8. The method of claim 7, wherein the scoring function is of the form:
$$φ = Re ( {\sum }_{k = 1}^{K} {w}_{rk} , {\overline{e}}_{sk} , {e}_{ok} )$$
where Re represents a real part of a complex number;
K represents the number of latent factors;
wᵣₖ represents the relation embedding for the kth latent factor;
ēₛₖ represents the complex conjugate of the kth latent factor for the subject entity; and
eₒₖ represents the kth latent factor for the object entity.

9. The method of claim 7, wherein the scoring function is of the form:
φ=(Re(wᵣ), Re(eₛ), Re(eₒ))+(Re(wᵣ), Im(eₛ), Im(eₒ))
−(Im(wᵣ), Re(eₛ), Im(eₒ))+(Im(wᵣ), Im(eₛ), Re(eₒ))
where Re represents a real part of a complex number;
Im represents an imaginary part of a complex number;
wᵣ represents the embedding of one of the at least one relation;
eₒ represents the latent factors of the object entity; and
eₛ represents the latent factors of the subject entity.

10. The method of claim 1, wherein the method includes predicting an entity for a relation from the reconstructed matrix.

11. The method of claim 1, wherein the method includes predicting an entity for a relation from the parameters of the scoring function.

12. The method of claim 1, wherein the training samples further comprise artificially generated negative training samples.

13. The method of claim 1, wherein the learning of the parameters of the scoring function comprises jointly learning the latent factors and relation parameters for each of the at least one relation, the relation parameters comprising a set of complex numbers.

14. The method of claim 1, wherein the learning of the parameters of the scoring function is performed with gradient descent.

15. The method of claim 1, wherein the input matrix is a normal matrix.

16. A computer program product comprising a non-transitory recording medium storing instructions, which when executed on a computer, causes the computer to perform the method of claim 1.

17. A system comprising memory which stores instructions for link prediction using a reconstructed matrix generated by the method of claim 1 and a processor in communication with the memory for executing the instructions.

18. A link prediction system comprising:
memory which stores values for training samples for at least one relation, the training samples comprising positive training samples in which a first of a set of entities is a subject in the relation and a second of the set of entities is an object in the relation;
a generation component which generates an input matrix for each of the at least one relation, based on the training samples;
a completion component which learns parameters of a scoring function which minimize an error between a reconstructed matrix and the input matrix, the parameters including a set of latent factors for each entity, each of the latent factors being a complex number; and
a processor which implements the generation component and the completion component.

19. The link prediction system of claim 18, further comprising at least one of:
a prediction component which predicts an entity for a relation based on the learned parameters; and
an output component which outputs at least one of the reconstructed matrix and a prediction generated by the prediction component.

20. A method for link prediction comprising:
providing an input matrix for each of at least one relation, each input matrix including a value for each of a subset of a set entity pairs represented in the input matrix, each entity pair including a first of the set of entities which is a subject in the respective relation and a second of the set of entities, which is an object in the respective relation;
with a processor, for each of the at least one relation, learning parameters of a scoring function which minimize an error between a reconstructed matrix and the input matrix, the parameters including a set of latent factors for each entity, each of the latent factors being a complex number, and parameters of the relation, elements of the reconstructed matrix each corresponding to the dot product of the latent factors for a first entity, the complex conjugates of the latent factors for a second entity, and the parameters of the relation;
performing at least one of:
outputting the parameters of the scoring function for performing link prediction; and
predicting an entity for a relation based on the parameters of the scoring function.
